(19) United States
(12) Patent Application Publication
(10) Pub. No.: US 2009/0327168 A1
(43) Pub. Date: Dec. 31, 2009

(54) PLAYFUL INCENTIVE FOR LABELING CONTENT

(75) Inventors: Kilian Quirin Weinberger, Mountain View, CA (US); Anirban Dasgupta, Berkeley, CA (US); Raghu Ramakrishnan, Santa Clara, CA (US); David Reiley, Palo Alto, CA (US); Martin Andre Monroe Zinkevich, Santa Clara, CA (US); Bo Pang, Sunnyvale, CA (US); Daniel Kifer, Sunnyvale, CA (US)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 12/147,342

(22) Filed: Jun. 26, 2008

(51) Int. Cl. G06F 3/048

(52) U.S. Cl. 706/11

(57) ABSTRACT

Embodiments are directed towards employing a playful incentive to encourage users to provide feedback that is useable to train a classifier. The classifier being associated with any of a variety of different settings, including but not limited to classifying: messages as ham/spam, images, advertising, bookmarking, music, videos, photographs, shopping, or the like. An animated image, such as a pet, provides an interface to the classifier that encourages and responds to user feedback. Users may share their classifiers or aspects thereof with other users to enable a community of knowledge to be applied to a classification task, while preserving privacy of the user feedback. One form of sharing may be within the context of a competitive game. Various evaluations may be performed on a classifier to indicate user feedback consistency, or quality. Classifiers may also be used to provide users with advertisements, products, or services based on the user's feedback.

### TECHNICAL FIELD

The present invention relates generally to managing information feedback over a network and, more particularly, but not exclusively to employing a playful animated image as a user interface to at least one classifier useable to receive user feedback on various content.

### BACKGROUND

Today, few people are unaware that businesses track their Internet activities. Obtaining information about a person's website browsing, and other network activities are performed for a variety of reasons. In many instances, the information obtained from tracking network activities allows businesses to focus advertisements towards a particular audience. By focusing the advertisements, the businesses anticipate that the advertisements are more likely to be viewed and thereby increase their business revenue. Focused advertisements are also less likely to be viewed as spam and therefore deleted or otherwise ignored by the recipient.

However, obtaining information from network activities provide a variety of other benefits as well. For example, obtaining information about people's networking activities as related to a product or service, allows a business to learn what features are useful and desirable and what features are less useful. The business may then improve the quality of their products and/or services, and even create a more desirable new product. Tracked network activities also provide businesses with information that might be useable for other people browsing the network. For example, some information obtained by tracking network activities may be provided to others to direct them towards new websites, products, and/or services. The tracked information might even be useable to warn others about problems observed on the network, or even about non-network related issues. Thus, information obtained from tracking a person's network activities can have many benefits.

Today, tracked information typically refers to information that may be obtained implicitly from monitoring of a person's activities. Tracking might employ cookies, as well as a variety of other features that may indicate what web pages a person viewed, how long they stayed on a given web page or website, and the like. Implicit information may also be gathered through registration data, trails through a network, through search activities, transactions on the network, toolbar data, or the like.

While such implicit information is an important source of information, an equally important source of information is explicit information that a person might provide. Examples of such explicit information might include feedback a person may provide about a product, service, or the like. For example, a person might explicitly provide feedback about music, a news article, even whether a received message is spam or not. Explicit feedback may sometimes even be viewed as more reliable than data collected through implicit techniques; that is, if, the feedback is not being provided with intent to skew results, or otherwise cause malicious acts.

Obtaining explicit feedback, however, is often difficult to do, because it often requires the person to expressly perform some action, such as entering their views, completing a survey form, or the like. Therefore, only a small group of network users actually provide explicit feedback. Moreover, gathering of information, whether it be implicitly obtained or explicitly provided, worries many people, especially as it relates to privacy concerns. Thus, there is a desire to obtain quality feedback that may be useable to improve products, services, and other data mining related activities. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a client device that may be included in a system implementing the invention;

FIG. 3 shows one embodiment of a network device that may be included in a system implementing the invention;

FIG. 4 illustrates a logical flow diagram generally showing one embodiment of an overview process for generally using playful animated images for classifiers;

FIG. 5 illustrates one embodiment of a non-exhaustive example of a playful animated image interface useable within a messaging application;

FIG. 6 illustrates one embodiment of a non-exhaustive example of an alliance of three playful animated images for a message classifier;

FIG. 7 illustrates one embodiment of a non-exhaustive example of a sharing of messaging classifiers;

FIG. 8 illustrates one embodiment of a non-exhaustive example of a classification break up of information for a particular message filtering mechanism; and

FIG. 9 illustrates one embodiment of a non-exhaustive example of a bonus message, highlighting mechanism.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, embodiments are directed towards providing a playful incentive based approach that is arranged to encourage users to contribute feedback useable to train a classifier, as well as to improve a quality of user feedback by creating a competitive setting. The quality feedback may then be used improve offerings to the users in terms of products, and services. As such, several non-exhaustive applications for using the quality feedback are described. One such application, mail spam detection, is described in detail below. In each case, the explicit feedback that is obtained may be used to train a classifier designed to perform a particular task. For example, in a messaging setting, the classifier may be used to perform spam/ham classification of messages for a user. Within the context of a music, photograph, or image setting, the classifier may be employed to attempt to identify new music, photographs, and/or products or services related to music, photographs, or the like, that might be of interest to a user.

The approach described herein employs an incentive based mechanism designed around using explicit feedback to initially train a classifier within a particular setting. For each user, the classifier may be represented by a playful animated image, such as a pet, symbol, icon, or the like. In one embodiment, as the user feeds their pet with explicit feedback the pet may grow or otherwise change shape, form, become animated, make sounds, or the like. For example, in one embodiment, the pet might initially be displayed to the user as an egg, or similar early stage form. Then as the user provides useful feedback or performs other desired actions, the pet becomes nourished and grows, becomes animated, or otherwise provides a variety of other actions, changes forms, or the like, directed towards encouraging the user to continue to provide feedback or perform an action useable by the classifier. In one embodiment, the pets may be employed within a competitive setting by allowing sharing and competition among other users' pets. The sharing and forms of competition is further directed towards sharing of a summarization of user feedback, using a private approach that is intended to allay privacy concerns. For example, rather than providing access to an input to a classifier, the classifier itself, or components that define at least a portion of the classifier may be made accessible to others, without providing an ability to reverse engineer the classifier, input content, or parts of the input content.

Embodiments of the invention may employ a pet or other animated image, which the user can feed with feedback. The animated image may have a plurality of scores, indicating a variety of information, including, but not limited to a frequency of user interactions, a quality of user feedback, a consistency of user feedback, or the like. Moreover, the animated image may be configurable to enable additional tasks, feedback types, displayed information, or the like, to be associated with the animated image. While the animated image operates as one form of user interface, others may also be employed. As a user interface, the animated image may be associated with one or more classifiers, which may be viewed as programs, scripts, algorithms, or the like, configured to receive user's feedback and to learn how to perform a specified task.

As used herein, therefore, the term “classifier” refers to any of a variety of decision mechanisms which accept values of some features or characteristics of a situation as input and produce as an output a label related to the input values. The label may be discrete or continuous That is a classifier performs a mapping from one feature space X to a discrete or continuous set of labels Y. Classifiers are useable to perform a wide variety of actions, including, but not limited to medicine, such as performing drug trial analysis; to financial areas, such as performing financial analysis; to telecommunications, such as performing error correction, signal decoding, or the like; and to data mining, such as performing purchase analysis, customer analysis, and the like.

One computing related example use of classifiers is in the area of organizing messages based on a determination of whether the message is spam or some other type of message. Such “message classifiers” may also be known as “spam filters.” Message classifiers may employ a variety of mechanisms to make such a determination including, but not limited to examining message headers, from addresses, message routing information, message content (e.g., a message body), a message attachment, or the like. User feedback may be used to train the message classifier based, in part, on whether a message is properly classified according to the user, or not. The training may modify various aspects of the classifier such that the classifier may learn and thereby improve a next classification.

Message classifiers, and classifiers as described herein, may employ a variety of approaches to organize messages (or other inputs), including, but not limited to artificial intelligence approaches, various machine learning algorithms, or the like. Non-exhaustive examples include Naïve Bayes, Support-Vector machines, logistic regression, perceptrons, Markovian discrimination approaches, or the like. Further, each of these algorithms may employ different variations, such as regularization, feature weighting, or the like. Non-exhaustive examples of such classifiers include, but are not limited to CRM114 Discriminator, POPFile, DSPAM, SpamAssassin, SpamBayes, or the like. However, in another embodiment, a classifier may be configured as a database, spreadsheet, or the like, useable to receive inputs, store, and/or otherwise organize the inputs, perhaps using data lookups, or the like. Moreover, in one embodiment, a user might be enabled to configure and/or provide their own selection of classification mechanisms. Thus, for example, in one embodiment, a classifier might be configurable to be virtually any mechanism for capturing user preferences about content. In one embodiment, the classifier may be configured to perform predictions, or the like.

Embodiments of the invention may also include a social network component that enables a user to allow friends, co-workers, family members, or the like, to feed their animated image and thereby train the associated classifier. In one embodiment, the user may also share their classifier for classification tasks with the other user. Thus, a collective knowledge of a community obtained through shared classifiers and their associated animated images may be used to perform classification tasks.

Embodiments further provide a global evaluation process that may be used to indicate how much a user's preferences are determined to be compatible or consistent with global preferences of a determined set of other users. In another embodiment, an evaluation process may also be employed that indicates how successful a user's classifier is at predicting the user's own feedback. Moreover, a competitive game environment may be employed that enables users to let their animated images/classifiers compete with animated images/classifiers from other users in performing selected tasks. For example, embodiments might maintain global datasets of ham/spam messages in order to judge a quality of a given user's classifier. Users that are determined to obtain a defined proficiency level for message classifications, for example, can then be granted an opportunity to compete with other users in classification of editor label corpora, or the like.

Applications may employ the playful animated image for the collection of explicit user input to a classifier, beyond merely message classifications. For example various embodiments may be used within image classification applications. In traditional image classifications, it appears that classification of images in terms of whether the image is considered to be beautiful, ugly, or the like, remains inherently a subjective task. Use of such playful animated images as interfaces to image classifiers may provide a natural way to let users label images as aesthetically pleasing or non-pleasing and to provide a framework to learn to adapt image searches to a user's particular taste or preference. A data instance may, for example, include images and their corresponding meta-data. In one embodiment, a classifier may be configured to find images that correspond to a user's preference or taste. A user may have a private set of images that the user rates. In order to verify whether the ratings of a user are of a reasonable quality, a global dataset of images may also be maintained. Thus, embodiments may be extended beyond merely a notion of interestingness to more objective tasks, such as finding out whether an image is that of a person, or of a particular object, or the like. For such tasks, a user might be asked to train their own classifier using their playful animated image on images that they can perform search and find type of tasks. A user might also be allowed to compete with other users on a particular set of editor labeled images for a particular task. By performing such actions, an ensemble of classifiers and labeled images become available that may be useable for multiple classification tasks.

Another application may include web searches and/or advertising. In this setting, a classification task might include training classifiers to find out search results and advertisements that may be relevant to a user. The user provides a training set of data by feeding their classifier with ratings on URLs, links, or the like, that the user might visit over a network, data store, or the like. The user may also be provided with a quality of the ratings by setting up competitions over classification tasks such as “identify URLs that answer a particular question,” or the like.

Embodiments of the invention are not limited to these examples, and other applications may also employ playful animated images as interfaces to various classifiers. For example, in still another application, a task may include predicting new URLs to visit or equivalently, organizing search results according to a user's preference for use in bookmarking, or the like. Music classifications may be still another application of various embodiments of the invention. Yet another application may include employing a classifier to provide shopping recommendations. For example, a playful animated image may be used to train a shopping classifier that may then subsequently be used to provide recommendations of products, services, merchants, or the like associated with a shopping experience for the user. Thus, it should be clear that the present invention is not limited by the non-exhaustive examples of applications for which the playful animated image interfaces may be employed. Therefore, such examples are not to be construed as narrowing the scope of the invention in any manner.

In one embodiment, a unique playful animated image might be associated with each classifier for an application. Thus, in one embodiment, one animated image might be associated with the application of messaging classifiers, while a different animated image might be associated with a music classifier, or the like. Thus, in one embodiment, the animated image might be associated with a message application, such as an email client, displayed and/or integrated with such application. Another animated image might be associated with a browser, or other client application interface.

However, the invention is not so limited. In another embodiment, a single animated image might be useable to operate as a user interface to a plurality of different classifiers for different applications. For example, the same animated image might be useable for different classifiers, such as for messages, music, bookmarking, or the like. In one embodiment, the animated image might be associated with a browser, or be downloadable for display on a desktop. Then, the user might select, in one embodiment, content that may be dragged onto the animated image. In one embodiment, each service provider of the content might have a unique identifier which may be passed to the animated image. The animated image may then determine, based on the unique identifier, to which classifier the content is to be directed. In another embodiment, each type of content might have a unique identifier associated with it, which may then be used to direct the content to an appropriate classifier. Thus, for example, web pages, email, images, audio files, or the like, might each be identified as different content types, each with different identifiers. In still another embodiment, the animated image, or another application, might determine based on a variety of features of the content to which classifier to direct the content. Moreover, in still another approach, several products might share a classifier, for example, such as for shopping items, or the like. Thus, the invention is not limited to a particular implementation of animated images, sorting, and routing approaches and a variety of approaches are envisaged.

Thus, various embodiments of the invention provide a mechanism for incentivizing users to perform actions, by casting them as a game with rewards. Within the game setting, explicit feedback may be obtained from the users on private data where, in one embodiment, no two users share any of their private data with each other. Instead, users share a digest or classifier that specifies their preferences for feedback. In one embodiment, a quality control system is provided that may evaluate a user's personal digest global data set and indicate a quality of that user's feedback. As such, various embodiments may be directed towards changing a user's overall perception of a primarily negative event, such as unsolicited messages, into a positive event, by recasting the event into an enabler for a game. Embodiments, as described within, further enable global collective problem solving, within personalized solutions and robustness against malicious attacks. Embodiments also provide novel approaches to evaluating a quality of a user's action by amortized testing as described further below. Moreover, embodiments provide a predictor for user's personal preferences on private data that may be used to provide the user with a targeted experience.

### Illustrative Operating Environment

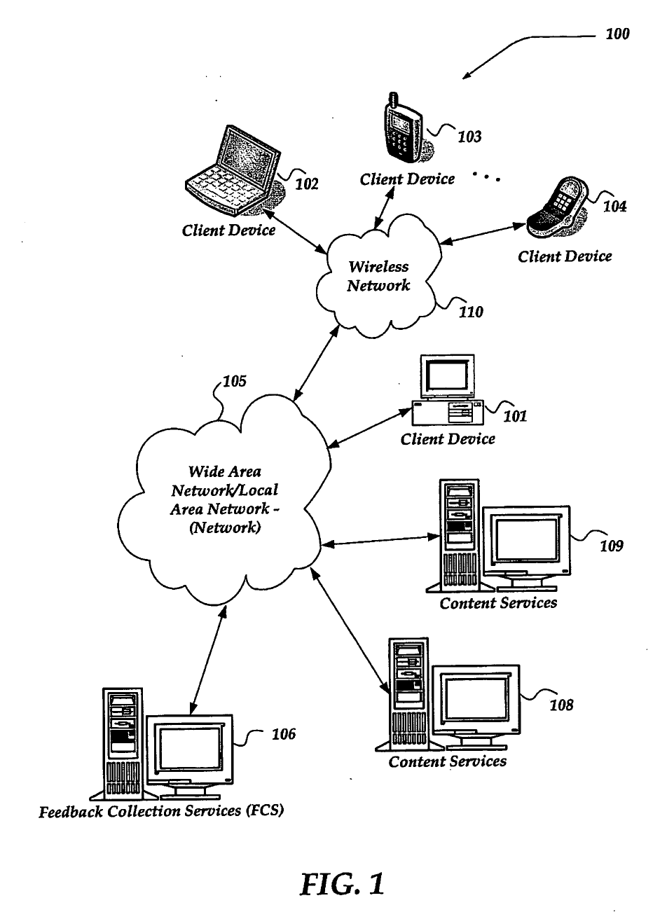

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)—(network) 105, wireless network 110, client devices 101-104, and content services 108-109, and feedback collection services (FCS) 106.

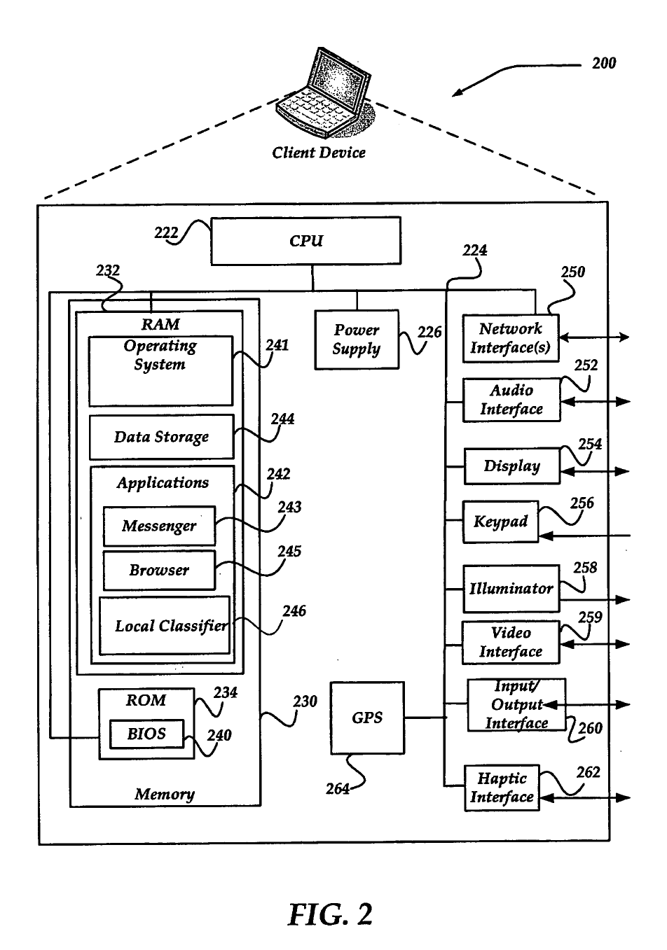

One embodiment of a client device usable as one of client devices 101-104 is described in more detail below in conjunction with FIG. 2. Briefly, however, client devices 102-104 may include virtually any mobile computing device capable of receiving and sending a message over a network, such as wireless network 110, or the like. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, or the like.

Client device 101 may include virtually any computing device that typically connects using a wired communications medium such as personal computers, multiprocessor systems, microprocessor-based or programmable consumer electronics, network PCs, or the like. In one embodiment, one or more of client devices 101-104 may also be configured to operate over a wired and/or a wireless network.

Client devices 101-104 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphics may be displayed.

A web-enabled client device may include a browser application that is configured to receive and to send web pages, web-based messages, or the like. The browser application may be configured to receive and display graphics, text, multimedia, or the like, employing virtually any web based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client devices 101-104 also may include at least one other client application that is configured to receive content from another computing device, such as content services 108-109, and/or FCS 106. The client application may include a capability to provide and receive textual content, multimedia information, or the like. The client application may further provide information that identifies itself, including a type, capability, name, or the like. In one embodiment, client devices 101-104 may uniquely identify themselves through any of a variety of mechanisms, including a phone number, Mobile Identification Number (MIN), an electronic serial number (ESN), mobile device identifier, network address, or other identifier. The identifier may be provided in a message, or the like, sent to another computing device.

Client devices 101-104 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, between another computing device. However, the present invention is not limited to these message protocols, and virtually any other message protocol may be employed.

Client devices 101-104 may further be configured to include a client application that enables the user to log into a user account that may be managed by another computing device. Such user account, for example, may be configured to enable the user to receive emails, send/receive IM messages, SMS messages, access selected web pages, or participate in a social networking activity. However, managing of messages or otherwise participating in other social activities may also be performed without logging into the user account.

A user of client devices 101-104 may employ any of a variety of client applications to access content, read web pages, receive/send messages, or the like. In one embodiment, each of client devices 101-104 may include a classifier, or be associated with a classifier that resides on another network device, that is useable to classify received messages, and/or other content, inputs, or the like.

In one embodiment, classifiers associated with a particular client device, particular user, or user's message account, address, or the like, are defined as local classifiers. Classifiers employed by other user's are defined as global classifiers. For example, a classifier for client device 101 is a local classifier to client device 101, but a global classifier to each of client devices 102-104. Similarly, a classifier that is local to client device 102 would be considered as a global classifier by client devices 101, and 103-104, and so forth. Again, while a classifier may reside within a given client device, the invention is not so limited, and a classifier for a given client device, user, user account, or the like, may also reside remotely, such as within DMS 106, or the like.

In any event, in one embodiment, a variety of classifiers may be employed. Such classifiers may be associated with different classification tasks, including, but not limited to message classifications, image classifications, web search and/or advertisement classifications, bookmark classifications, music classifications, video classifications, or the like. For example, in one embodiment, one type of message classifiers may be directed towards evaluating a message to determine whether the message is a spam message, or not. Various message classifiers may further determine whether a message includes, or might include, a virus, Trojan horse, malware, or the like. The message classifiers may be configured and arranged to examine various features of a message to make such a determination. Many of these message classifiers may include a training period, or on-going training configuration, where the message classifier might determine whether a message is spam or not, based on input from a user, a current folder location of a message, or the like. In one embodiment, such training might include changing a weight that the message classifier might apply to a feature, adding/deleting of features to examine, or the like. In one embodiment, many message classifiers are configured to provide a classification or prediction of a message, then, modify various weights, and/or other parameters, local to the message classifier based on feedback from the user on the message classifier's prediction. For example, the message classifier might indicate that a message is spam, but the user subsequently determines that the message is not spam and, for example, moves the message to an inbox from a spam folder. The actions of the user of moving the message may be used to train the message classifier for a next message. However, various embodiments of the message classifiers may employ weighted inputs from a community of other message classifiers to classify a message. In one embodiment, a user might enable sharing of their classifier, and/or components of their classifier with other users. In another embodiment, the user might enable other users to train their classifier by providing input.

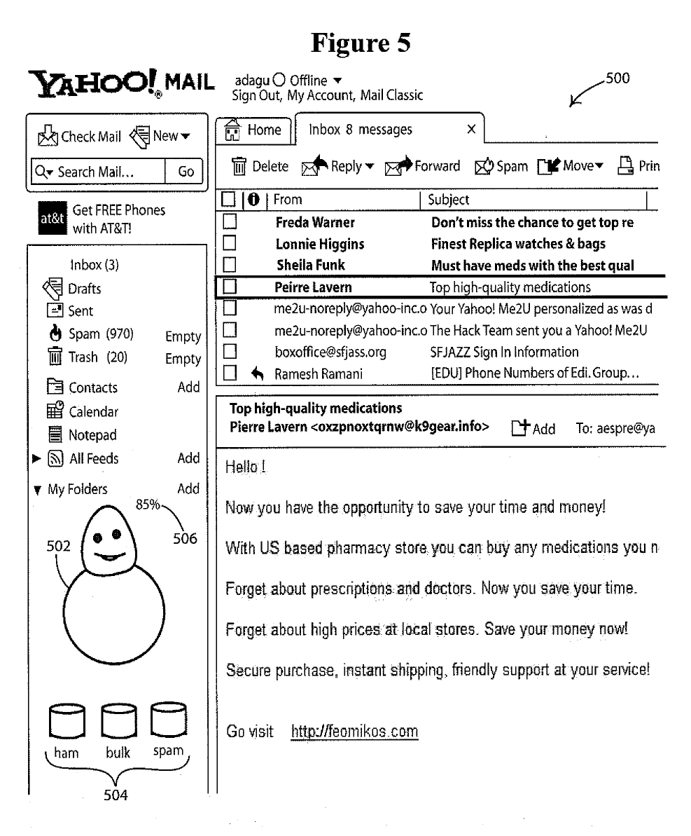

In one embodiment, a playful animated image may be provided for use with a given classifier, or defined set of classifiers. The playful animated image may change its shape, size, perform various actions, provide sounds, text, or the like, based on different inputs, and/or requests for actions to be performed, or the like. Various non-exhaustive embodiments of such playful animated images are described in more detail below in conjunction with FIGS. 5-8. Such illustrated examples, however, are not intended to narrow the invention, and virtually any shape, size, color, or form, of playful animated image may be employed. In one embodiment, a user might be provided with a set of images from which they might select. In another embodiment, the user might select an image and provide it to an interface, such that the user's provided image might then be used as a playful animated image interface to one or more classifiers.

As noted below, the playful animated image can be fed by the user with various explicit user feedback regarding different content. Moreover, the user may configure the playful animated image for use in sharing at least some information about an associated classifier, access another user's classifier or related data, or the like. The user may also configure their animated image/classifier to be trained by other users. The user may further employ the playful animated image to play games, compete in games, develop scores, evaluate a quality of a classifier associated with the image, or do a variety of other actions with the animated image/classifier(s).

Wireless network 110 is configured to couple client devices 102-104 with network 105. Wireless network 110 may include any of a variety of wireless sub-networks that may further overlay stand-alone ad-hoc networks, or the like, to provide an infrastructure-oriented connection for client devices 102-104. Such sub-networks may include mesh networks, Wireless LAN (WLAN) networks, cellular networks, or the like.

Wireless network 110 may further include an autonomous system of terminals, gateways, routers, or the like connected by wireless radio links, or the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G), 4th (4G) generation radio access for cellular systems, WLAN, Wireless Router (WR) mesh, or the like. Access technologies such as 2G, 2.5G, 3G, 4G, and future access networks may enable wide area coverage for client devices, such as client devices 102-104 with various degrees of mobility. For example, wireless network 110 may enable a radio connection through a radio network access such as Global System for Mobile communication (GSM), General Packet Radio Services (GPRS), Enhanced Data GSM Environment (EDGE), Wideband Code Division Multiple Access (WCDMA), Bluetooth, or the like. In essence, wireless network 110 may include virtually any wireless communication mechanism by which information may travel between client devices 102-104 and another computing device, network, or the like.

Network 105 is configured to couple FCS 106, content services 108-109, and client device 101 with other computing devices, including through wireless network 110 to client devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between computing devices.

FCS 106 includes virtually any network computing device that is configured to manage one or more classifiers for client devices 101-104. In one embodiment, FCS 106 may provide to client devices 101-104 one or more playful animated images for use as a user interface to one or more classifiers. In another embodiment, FCS 106 may provide the animated images and classifiers to content services 108-109 for use in performing various classification tasks. FCS 106 may further provide an ability to allow a user to select an animated image from a set of available images, or to provide an image for animation from any of a variety of other sources. In still another embodiment, FCS 106 may enable a user to provide a classifier to be associated with an animated image, and/or select from a set of defined classifiers for use with a type of content, a particular classification action, or the like.

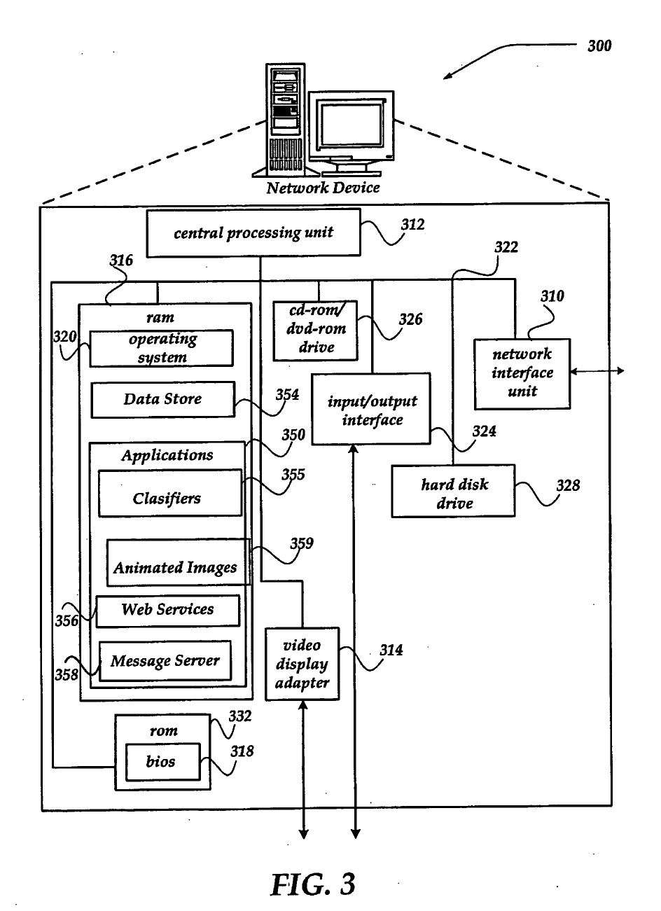

One embodiment, of a network device useable for one of content services 108-109 is described in more detail below in conjunction with FIG. 3. Briefly, however, content services 108-109 include virtually any computing device that is configured and arranged to provide any of a variety of content and/or services over a network. As such, content services 108-109 may operate as a web service for enabling access to such content/services including, but not limited to blog information, educational information, music/video information, social networking content and/or services, messaging, or any of a variety of other content/services that may be accessible over a network. However, content services 108-109 are not limited to web servers, and may also operate a messaging server, a File Transfer Protocol (FTP) server, a database server, or the like. Additionally, each of content services 108-109 may be configured to perform a different operation. Thus, for example, content provider 108 may be configured as a website server for multimedia content, while content service 109 is configured as a database server for a variety of content. Moreover, while content services 108-109 may operate as other than a website, they may still be enabled to receive an HTTP communication.

In one embodiment, for example, one of content services 108-109 may include a message server that is configured to receive messages and route them to an appropriate client device, or the like. Thus, content services 108-109 may include a message transfer manager to communicate a message employing any of a variety of email protocols, including, but not limited, to Simple Mail Transfer Protocol (SMTP), Post Office Protocol (POP), Internet Message Access Protocol (IMAP), NNTP, and the like. However, content services 108-109 may also include a message server configured and arranged to manage other types of messages, including, but not limited to SMS, MMS, IM, or the like.

Content services 108-109 may, in one embodiment, receive from FCS 106 one or more animated images, and/or classifiers for use in managing various classification tasks. For example, in one embodiment, content services 108-109 may receive from FCS 106 one or more message classifiers useable to classify received messages and organize them into different message folders based, in part, on the classification. However, in another embodiment, content services 108-109 might provide content, inputs, or the like, to FCS 106 for use with one or more classifiers. Thus, in another embodiment, FCS 106 might retain or otherwise manage the classifiers. In still another embodiment, animated images and/or classifiers may be downloadable to a client device.

In one embodiment, message classifiers may provide predictions that the message is a spam message, a bulk message, a ham message, or the like. FCS 106 and/or content services 108-109 may then send the message to a message folder based on the classification. A user associated with a user account for the message folder may provide feedback regarding the classification of the message. FCS 106 and/or content services 108-109 may enable the feedback to be used to modify characteristics of one or more message classifiers. FCS 106 and/or content services 108-109 may also employ several message classifiers to generate a single message prediction of a given message. In one embodiment, FCS 106 and/or content services 108-109 may send a message that is intended for a user account to classifiers associated with other user accounts. FCS 106 and/or content services 108-109 may send the message transparently to the other classifiers to obtain a message prediction from the other classifiers. That is, in one embodiment, the message may be sent to the other (global) classifiers in a manner that preserves privacy of the message from other users, and may further employ the other classifiers in a manner that is transparent or otherwise unknown to a user associated with the other classifiers.

A message classification system may employ a weighting mechanism to combine the plurality of message predictions to generate a single message prediction useable to organize the message into a message folder. By employing a community of classifiers various embodiments may be able to obtain the dynamic collective wisdom of the community to whether a message is spam, ham, or another type of message.

Devices that may operate as FCS 106 and/or content services 108-109 include, but are not limited to personal computers, desktop computers, multiprocessor systems, microprocessor-based or programmable consumer electronics, network PCs, servers, network appliances, and the like.

Although FCS 106 and content services 108-109 are illustrated as distinct network devices, the invention is not so limited. For example, a plurality of network devices may be configured to perform the operational aspects of FCS 106, and/or content services 108-109. Moreover, FCS 106 may provide components, such as animated images, user interfaces, classifiers, or the like, to content services 108-109 for use within content services 108-109. Thus, the invention is not limited to a single implementation, and a variety of different implementations, and configurations may be employed, without departing from the scope of the invention. The invention therefore, is not to be construed as being limited by the non-exhaustive example implementations provided herein.

### Illustrative Client Environment

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. Client device 200 may represent, for example, one of client devices 101-104 of FIG. 1.

As shown in the figure, client device 200 includes a processing unit (CPU) 222 in communication with a mass memory 230 via a bus 224. Client device 200 also includes a power supply 226, one or more network interfaces 250, an audio interface 252, video interface 259, a display 254, a keypad 256, an illuminator 258, an input/output interface 260, a haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth™, infrared, Wi-Fi, Zigbee, r any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Video interface 259 is arranged to capture video images, such as a still photo, a video segment, an infrared video, or the like. For example, video interface 259 may be coupled to a digital video camera, a web-camera, or the like. Video interface 259 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, Wi-Fi, Zigbee, or the like. Haptic interface 262 is arranged to provide tactile feedback to a user of the client device. For example, the haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, a client device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer readable storage media for storage of information such as computer readable instructions, data structures, program modules, or other data. Mass memory 230 stores a basic input/output system (“BIOS”) 240 for controlling low-level operation of client device 200. The mass memory also stores an operating system 241 for controlling the operation of client device 200. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 244, which can be utilized by client device 200 to store, among other things, applications 242 and/or other data. For example, data storage 244 may also be employed to store information that describes various capabilities of client device 200, as well as store an identifier. The information, including the identifier, may then be provided to another device based on any of a variety of events, including being sent as part of a header during a communication, sent upon request, or the like. In one embodiment, the identifier and/or other information about client device 200 might be provided automatically to another networked device, independent of a directed action to do so by a user of client device 200. Thus, in one embodiment, the identifier might be provided over the network transparent to the user.

Moreover, data storage 244 may also be employed to store personal information including but not limited to contact lists, personal preferences, data files, graphs, videos, or the like. Data storage 244 may further provide storage for user account information useable with one or more message addresses, message folders, or the like. Thus, data storage 244 may include various message storage capabilities to store and/or otherwise manage message folders, such as email folders for spam messages, ham messages, bulk messages, inbox messages, deleted messages, or the like. Data storage 244 may also be useable to store a variety of other data useable by any of a variety of other classifiers, including, but not limited to user preferences for the classifiers, and the like. Moreover, in at least one embodiment, a user's playful animated image may be stored within data storage 244. At least a portion of the information may also be stored on a disk drive or other storage medium (not shown) within client device 200.

Applications 242 may include computer executable instructions which, when executed by client device 200, transmit, receive, and/or otherwise process messages (e.g., SMS, MMS, IM, email, and/or other messages), multimedia information, and enable telecommunication with another user of another client device. Other examples of application programs include calendars, browsers, email clients, IM applications, SMS applications, VOIP applications, contact managers, task managers, transcoders, database programs, word processing programs, security applications, spreadsheet programs, games, search programs, and so forth. Applications 242 may include, for example, messenger 243, and browser 245.

Browser 245 may include virtually any client application configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may also be employed. In at least one embodiment, a plug-in, like, script, or the like, may be associated with browser 245 that provides display and access of a playful animated image useable with at least one classifier.

Messenger 243 may be configured to initiate and manage a messaging session using any of a variety of messaging communications including, but not limited to email, Short Message Service (SMS), Instant Message (IM), Multimedia Message Service (MMS), internet relay chat (IRC), mIRC, and the like. For example, in one embodiment, messenger 243 may be configured as an IM application, such as AOL Instant Messenger, Yahoo! Messenger, .NET Messenger Server, ICQ, or the like. In one embodiment messenger 243 may be configured to include a mail user agent (MUA) such as Elm, Pine, MH, Outlook, Eudora, Mac Mail, Mozilla Thunderbird, or the like. In another embodiment, messenger 243 may be a client application that is configured to integrate and employ a variety of messaging protocols. In one embodiment, messenger 243 may employ various message boxes or folders to manage and/or store messages. In one embodiment, a plug-in, script, or the like, may be associated with messenger 243 that enables a user to view and otherwise access a playful animated image.

### Illustrative Network Device Environment

FIG. 3 shows one embodiment of a network device, according to one embodiment of the invention. Network device 300 may include many more components than those shown. The components shown, however, are sufficient to disclose an illustrative embodiment for practicing the invention. Network device 300 may represent, for example, one of content services 108-109 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. For example, mass memory might include data store 354. Data store 354 may be include virtually any mechanism usable for store and managing data, including but not limited to a file, a folder, a document, or an application, such as a database, spreadsheet, or the like. Data store 354 may manage information that might include, but is not limited to web pages, user preferences, classifier information, animated images, rules, policies, test data for classifiers, test results for classifiers, contact lists, identifiers, profile information, tags, labels, or the like, associated with a user, as well as scripts, applications, applets, and the like. Moreover, at least some of the data and other information, or the like, storable in data store 354 may also be stored in another device, such as cd-rom/dvd-rom drive 326, hard disk drive 328, or other computer-readable storage medium.

One or more applications 350 may be loaded into mass memory and run on operating system 320. Examples of application programs may include transcoders, schedulers, calendars, database programs, word processing programs, HTTP programs, customizable user interface programs, IPSec applications, encryption programs, security programs, VPN programs, web servers, account management, and so forth. Applications 350 may include web services 356, Message Server (MS) 358, Classifiers 355, and animated images 359.

Web services 356 represent any of a variety of services that are configured to provide content, including messages, over a network to another computing device. Thus, web services 356 include for example, a web server, messaging server, a File Transfer Protocol (FTP) server, a database server, a content server, or the like. Web services 356 may provide the content including messages over the network using any of a variety of formats, including, but not limited to WAP, HDML, WML, SMGL, HTML, XML, cHTML, xHTML, or the like. In one embodiment, web services 356 may interact with message server 358, classifiers 355 and/or animated images 359 to enable classification of input.

Message server 358 may include virtually any computing component or components configured and arranged to forward messages from message user agents, and/or other message servers, or to deliver messages to a local message store, such as data store 354, or the like. Thus, message server 358 may include a message transfer manager to communicate a message employing any of a variety of email protocols, including, but not limited, to Simple Mail Transfer Protocol (SMTP), Post Office Protocol (POP), Internet Message Access Protocol (IMAP), NNTP, or the like.

However, message server 358 is not constrained to email messages, and other messaging protocols may also be managed by one or more components of message server 358. Thus, message server 358 may also be configured to manage SMS messages, IM, MMS, IRC, mIRC, or any of a variety of other message types.

Animated images 359 includes any of a variety of applications, icons, scripts, applets, or the like, that may be useable to provide a display of a playful animated image as at least a user interface to one or more classifiers. In one embodiment, an animated image may be selected and useable for display within a user's browser, message application interface, or the like, for use in managing one or more content classification tasks. In one embodiment, the animated image(s) may be downloadable onto a client device.

In another embodiment, each application, such as messaging, browsing, or the like, might have associated with it a different animated image for use in classification tasks. In one embodiment, the animated image might be configured to receive input from a user, or another source, and determine which classifier the input is to be directed. For example, in one embodiment, each content service, provider of the content, or the like, might have a unique identifier which may be passed to the animated image. The animated image may then determine, based on the unique identifier, to which classifier the content is to be directed. In another embodiment, each type of content might have a unique identifier associated with it, which may then be used to direct the content to an appropriate classifier. In still another embodiment, the animated image, or another application, might determine based on a variety of features of the content to which classifier to direct the content.

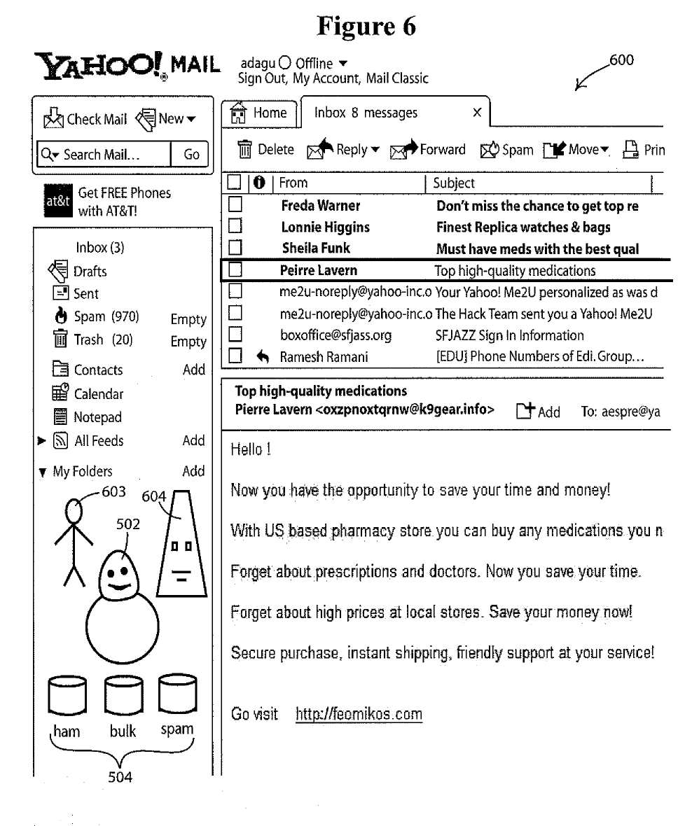

Moreover, animated images 359 may include images that are configured to be useable by a single user, sharable by a plurality of users, or the like. Animated images 359 may further be configured to display to a user, a plurality of information, including, but not limited to scores, indicating a variety of information, including, but not limited to a frequency of user interactions, a quality of user feedback, a consistency of user feedback, or the like. Various non-exhaustive examples of animated images are illustrated in FIGS. 6-8.

Classifiers 355 include any of a variety of applications, scripts, databases, spreadsheets, or the like, useable to operate as a classifier as described herein. In one embodiment, classifiers 355 may include a plurality of different applications, scripts, or the like. In one embodiment, one or more classifiers within classifiers 355 may be downloadable onto a client device.

In one embodiment, classifiers 355 may include classifiers that are associated with a given user, and/or sharable by a plurality of users. Classifiers 355 may include classifiers that are configured to receive user preferences, and to perform actions based on the received user preferences. In one embodiment, a single animated image from within animated images 359 may provide a single user interface to a plurality of different classifiers. However, in another embodiment, each classifier may have a unique animated image associated with it.

### Generalized Operation

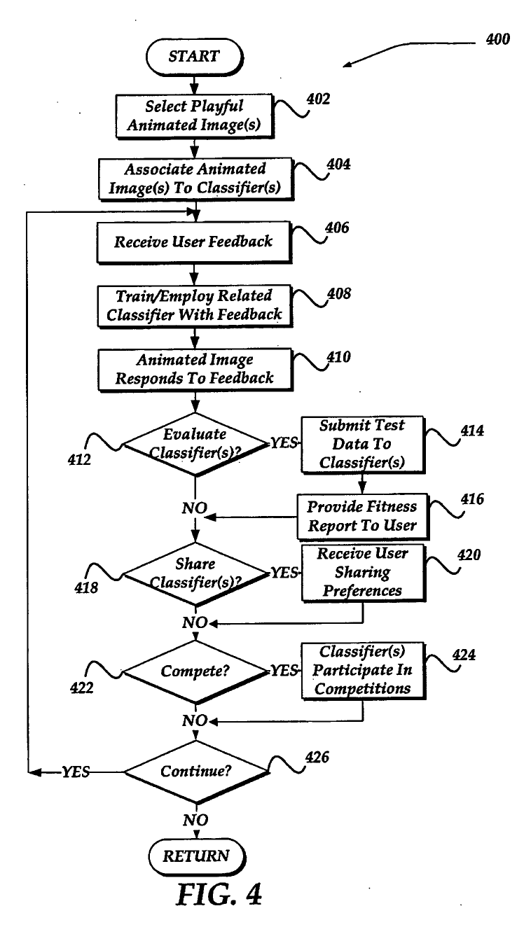

The operation of certain additional general aspects of the invention will now be described with respect to FIG. 4. Following a discussion of FIG. 4, non-exhaustive use cases will be described to provide illustrative example applications for the invention.

Process 400 of FIG. 4 may be implemented within content services 108-109, and/or FCS 106 of FIG. 1. However, in another embodiment, at least some of process 600 may also be implemented within one or more of client devices 101-104.

As shown, process 400 may begin, after a start block, at block 402, where a user may select to employ a playful animated image or images. In one embodiment, the user might be presented with an opportunity to sign up for a use of the images. In another embodiment, the user might be presented with an opportunity to use images, without having to perform a registration, or other ‘sign up’ activity.

At block 402, the user might be presented with a variety of playful animated images from which to select. In another embodiment, the user might be allowed to provide an animated image for use from another source. In one embodiment, the user might be able to select an image, enable it to perform actions, such as growing, moving, making sounds, or the like, as part of the user's process for selecting an animated image. In one embodiment, the user might select a plurality of images, where each image might be useable for a different classification task. In another embodiment, the user might select a single image, useable for a plurality of different classification tasks.

Moving to process 404, the user may associate a selected image to one or more classification tasks. As stated above, in another embodiment, an image might be associated with a unique task. Moreover, in one embodiment, the user might make such association, within a particular application. For example, when the user is within a messaging client, the animated image might be dragged over a messaging client interface to generate the association between messaging classification tasks and the animated image. In another embodiment, the user might be within a web browser application. In this instance, the association might arise again by dragging the animated image within a given proximity, or over, the browser interface displayed. Because a browser may enable a user to access messages, music, perform shopping actions, and a variety of other tasks, in one embodiment, a single animated image might be useable for a variety of browser-capable classification related tasks. However, in another embodiment, the user may still be allowed to assign different images to different tasks for the browser. Thus, for example, when the user opens a messaging window within their browser, one animated image might appear, and when the user opens a shopping window, or the like, within their browser, a different animated image might appear. Furthermore, as noted, in one embodiment, the animated image might employ information, such as content type identifiers, or the like, to determine which classifier to direct input, content, towards. Thus, it is apparent, that the invention allows a user flexibility in relating one or more images to classification tasks. However, in another embodiment, the association might be established automatically, independent of a user action.

Processing then moves to block 406, where the user may perform any of a variety of actions. For example, the user might perform various shopping activities, browsing activities, messaging activities, or the like. During such activities, the user may provide feedback useable by a classifier. In one embodiment, the user might select to drag some icon, display, message, or the like, onto the animated image, or perform some other action that is useable by the classifier to provide user feedback. For example, a user might provide feedback by changing a result of a classifier, such as by moving a message labeled as spam, ham, or the like, into another folder/box.

Processing then flows to block 408, where the provided feedback may be used by the classifier to train the classifier. In one embodiment, the feedback may also be used to perform a classification task. For example, in one embodiment, the input might be related to selection of music for purchase by the user. The user might determine that a particular piece of music is enjoyable, and provide explicit user feedback about the music. The animated image might then provide the feedback to the classifier. The classifier, in turn, might then select music that might be related to the piece that the user identified as enjoyable.

The process flows next to block 410, where the animated image may provide a response based on receiving the user's input. For example, during an initial training of the classifier, the animated image might appear as an egg, a baby pet, or the like. Then, as the user provides explicit feedback, the egg might hatch, the baby pet might grow, or the like. In one embodiment, the animated image might jump, shake, make sounds, dance, or perform any of a variety of other actions, sounds, or the like. It should be noted, that the responses that the animated image might provide are not restricted to these examples, and virtually any action, sound, or transmogrification might occur, without departing from the scope of the invention.

Processing continues next to decision block 412, where a determination is made whether the classifier or classifiers for a user are to be evaluated. Such evaluations might include determining how much a user's preferences as represented by the training of the classifier are compatible or consistent with a set of other users' preferences as determined by results from their classifiers. The evaluations might also be performed to provide information about how successful the user's classifier(s) are in predicting the user's own feedback. The evaluation of the user's classifier(s) is not limited to these examples, and a variety of other evaluations may be performed as well. Moreover, in one embodiment, the user might select to have one or more evaluations be performed, while in another embodiment, a content service, system administrator, or the like, might select to have one or more evaluated performed on the user's classifier(s). In any event, if evaluations are to be performed, processing flows to block 414; otherwise, processing flows to decision block 418.

At block 414, the one or more evaluations may be performed for the user's one or more classifiers. Processing then flows to block 416, where, in one embodiment, the results of the evaluations might be displayed next to, over, or within some proximity of the animated image. In another embodiment, results of the evaluations might be sent to the user over a messaging mechanism, such as email, or the like. In still another embodiment, the results of the evaluations might be hidden and/or displayable by some other action of the user, such as performing a mouse-over of a portion of the animated image(s), selecting a display option, or the like. In any event, processing then flows to decision block 418.

At decision block 418, a determination is made whether the user has selected to share one or more classifiers with other users, and/or to select to employ one or more other user's classifiers with the user's own classifier(s). If so, then processing flows to block 420; otherwise, processing flows to decision block 422. At block 420, the user may provide their sharing preferences, including whether others may use some of the user's classifiers, whether the user's classifiers are private and un-useable with at least some users, and/or whether the user is to use classifiers from other users. Processing then returns to decision block 422.

At decision block 422, the user may select to participate in any of a variety of games, contests, or the like, where one or more classifier's of the user's is employed in performing various classification tasks. If so, the process flows to block 424; otherwise, processing flows to decision block 426. At block 424, the user may compete against other users, receive awards, or the like. In one embodiment, the user's classifier associated with the competition might perform various actions, sounds, or the like, based on the competition(s). Thus, the user may continue to nurture their animated image, compete through their animated images, and perform a variety of other social networking activities through their animated images. Processing flows next to decision block 426.

At decision block 426, a determination is made whether to continue nurturing and employing animated images for classification tasks. If so, processing loops back to block 406; otherwise, processing may return to a calling process to perform other actions.

It should be noted that the above process illustrates one possible flow of actions, however, the invention is not limited to this particular flow. For example, a user might select to determine sharing of their animated image (blocks 418 and 42) before selecting to train the related classifier (blocks 406, 408, and 410). Thus, the above process is not to be construed as limiting the invention in any manner, and clearly other flows, may be employed, including performing at least some of the blocks concurrently, without departing from the invention.

Moreover, throughout use of the animated images by the user, the animated image may provide various responses, beyond those mentioned at block 410. For example, in one embodiment, it might be determined that a classifier has not been fed or otherwise trained, used, or the like, for some period of time. In which instance, the animated image might provide some action, or other indication that it might want to be fed. The invention is not limited to merely this example, however, and the animated image might provide a response to the user for a variety of other reasons, including, but not limited, to indicating that it wants to compete, that the user is being asked to share by another user, that the classifier is being or has been recently evaluated by other than the user, or the like.

Moreover, it will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

### Illustrative Use Cases for Playful Animated Images as Interfaces to Classifiers

### Illustrative Use Cases for Messaging:

Several non-exhaustive use cases will now be described to provide illustrative example applications for the invention with respect to at least FIGS. 5-9. The animated images and application context shown may include more or less components than those shown in FIGS. 5-9; however, the components shown are sufficient to disclose an illustrative embodiment for practicing the present invention. A first use case that is described is within the context of message filtering, while a second use case is described within the context of labeling images. It should be noted however, that the invention is not to be construed as limited by the following non-exhaustive use cases, and a plurality of other variations are envisaged for use with these applications, as well as for a variety of other applications.

In any event, as many message users are aware, the amount of spam and/or other undesired messages ending up in their message inboxes have been steadily increasing. As a counter-measure, many service providers, businesses and the like, are developing various spam filters, virus filters, and the like, in attempt to reduce the amount of undesirable messages.

However, one of the problems with many of the developed filters is a lack of labeled data. That is, a filter often needs to be trained to identify whether a message is desirable or not desirable. This training often uses messages that are labeled as such by a user. While many filters may provide an infrastructure that enables a user to label a message as spam, ham, or the like, currently many users do not provide any feedback at all, and few provide sufficient feedback that enables a filter to become trained as an effective classifier for the user. While there may be a variety of reasons that a user does not provide feedback to train a classifier, at least one of the reasons may be that a user is often unaware of such actions, or is unaware of any long-term gain obtained by such training.

Thus, the present invention provides one approach to resolving this lack of user feedback to classifiers. In one embodiment, therefore, a playful animated image is provided that encourages the user to perform actions by interacting with the image. In the context of messaging, the animated image might be a cute pet, monster pet, or any of a variety of other images, configured to eat spam messages, ham messages and in response grows, thrives, and responds to the user's feedback. For example, whenever a user decides to label (provide feedback) on a message, the user may, instead of clicking on a spam/ham button, feed their pet, and may be rewarded with an animation of the pet. In this manner, the invention provides a framework that emphasizes an impression that the users are working for their own benefit to train their personalized classifiers (through the virtual pets).

In addition to visual, and/or oral feedback, the animated image may provide other attributes, including, but not limited to size, and fitness. In one embodiment, the size of the animated image may change (or the image may grow, transmogrify, or the like) as it ‘eats’ more messages. The fitness attribute may be based, for example, on a classification rate of the classifier on some validation or evaluation data set. In one embodiment, such data set might be unknown by the user. However, the user may influence a fitness score for their animated image by the user's act of separating ham from spam messages, or the like.

FIG. 5 illustrates one embodiment of a non-exhaustive example of a playful animated image interface useable within a messaging application. As shown, the playful animated image 502 of screen shot 500 may be configured by the user, and/or selected from a variety of images provided to the user. As shown also, in one embodiment of the messaging use case, various food bowls 504 may be displayed, including, but not limited to a spam bowl, ham bowl, and a bulk bowl. The user may then select one or more received messages and drag the selected message(s) onto one of the food bowls 504. In one embodiment, a bulk bowl within the food bowls 504 might be used, for example, to allow for user-specific spam that might not be used for verification, but might be otherwise be used for personalized filtering. For example, newsletters might represent such bulk messages automatically generated from various social networking websites.

As noted, animated image 502 might initially be displayed as a small image, perhaps as a baby, egg, or the like, in one embodiment. Then, as the user feeds the animated image 502, it may grow, perform actions, make sounds, display messages, or the like. Each time a user moves a message onto a bowl, the message is added to their training corpus for a classifier associated with the animated image 502, and the classifier is updated. Thus, a user may be encouraged to label incoming messages and provide feedback to a classifier.

Based on a determined frequency, event, condition, or the like, a set of validation data may be assembled and used to evaluate a user's classifier. For example, in one embodiment, the set might be used to evaluate a user's classifier on a weekly basis, monthly basis, or even based on an event such as having seen a change in a type of spam by a content provider, or the like. In one embodiment, the evaluation might not be performed on a classifier until a user has fed it with some minimum number of messages. The minimum number may be selected based on a type of classifier, type of messages being classified, statistical analysis, engineering judgment, or virtually any other criteria. For example, in one embodiment, the evaluation might not be performed until at least 30-70 messages have been fed to the animated image 502 by the user. In one embodiment, for example, the validation data set might include messages that are objectively determined to be spam and/or non-spam messages. A result of the evaluation may then represent, for example, a classifier's fitness score 506. In one embodiment, the fitness score 506 might be displayed or displayable as a number. In another embodiment, the fitness score might be represented by another mechanism, such as the animated image 502's physical constitution, or the like. In one embodiment, it might be relatively easy to initially make the animated image 502 more fit through appropriate feedings. However, as the associated classifier's fitness improves, in one embodiment, it may become more difficult to improve a score. In this manner, fitness score 506 may be used to encourage additional user feedback.

In one embodiment, a user may have an option to make aspects of the classifiers/images private or public. That is, if the user selects the classifier/image to be private, then, in one embodiment, access may be restricted to the user, and other users may be unable to access it. If the user selects to make the classifier/image public, the user may select to enable one or more other users to access a classifier, portions of a classifier, or the like. In one embodiment, the user might also allow one or more other users to feed the user's classifier(s). Thus, in one embodiment, the selected other users might be able to employ the user's classifier for performing classification tasks, but may in another embodiment train the user's classifier. In this manner, the user's classifier may then be exposed to potentially a wider variety of spam/ham messages, which in turn has the potential of radically improving the user's classifier(s)' performance.

FIG. 6 illustrates one embodiment of a non-exhaustive example of an alliance of three playful animated images for a message classifier. Shown in screen shot 600 is a configuration of animated images 502, and 602-603, where a user associated with animated image 502 may be enabled to also feed the two other animated images 602-603. Where a user is enabled to feed another user's animated image, the users may build an alliance and share a combined fitness score for their classifiers. Thus, the present invention is configured with a feedback selection that encourages viral spread of information, forming a collective knowledge useable for classification tasks.

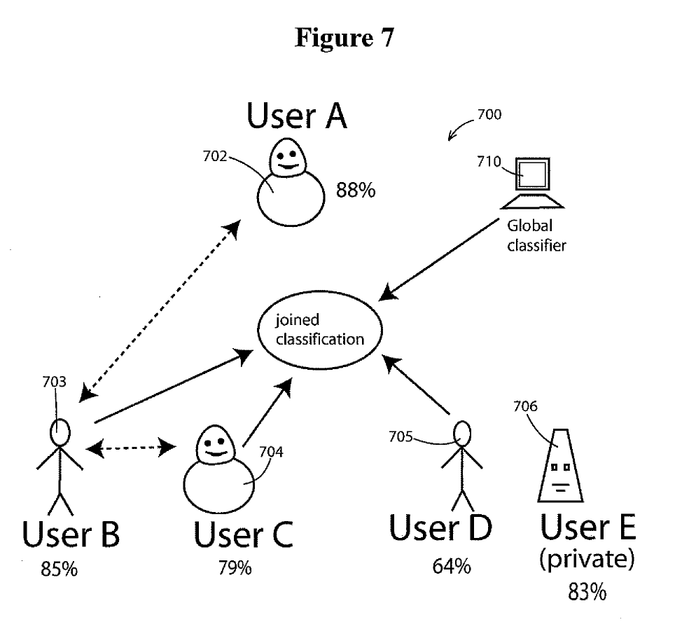

FIG. 7 illustrates one embodiment of a non-exhaustive example of a sharing of messaging classifiers. Shown in schematic layout 700 is one embodiment of a possible classification arrangement between users. As seen, user 700 has friends 703-705. However, as shown, not all of them might share their animated images/classifiers. One such example is shown as friend 706. As further illustrated, user 700 might select a subset of friends (703-705) in combination with user 700's own classifier to classify messages. In addition, friend 703 shows an example of a friend allowing user 700 to feed friend 703's classifier, and thereby illustrates one embodiment of an example alliance. In one embodiment, user 700's fitness score may be based on a combination of fitness scores from the friends 703-705, and user 700's own self fitness score. Moreover, schematic layout 700, or a substantially similar interface, may be provided to enable a user to establish sharing preferences. However, other interfaces may also be used, including, but not limited to lists, databases, spreadsheets, address books, or the like.

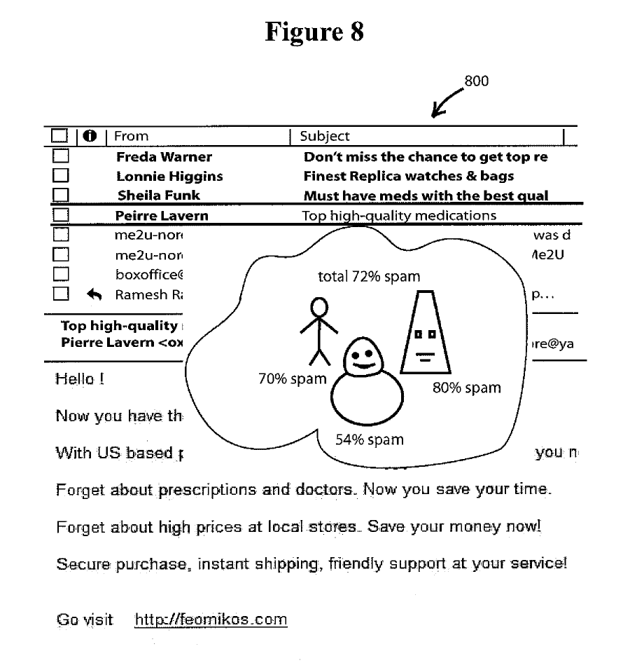

As may be readily apparent, use of the present invention provides a user a view of classifiers as no longer being merely an abstract algorithm and instead is directed towards enabling a user to become emotionally involved with a classifier and its actions through the playful animated image interface. Moreover, a user is likely to be more inclined towards forming alliances with other users whereby a community's collective knowledge and experience may be applied to various classification applications. FIG. 8 illustrates one embodiment of a non-exhaustive example of a classification break up of information for a particular message filtering mechanism useable to perform such collaborative classification actions.

Through the use of such playful animated images, explicit user feedback may be obtained. Moreover, such explicit user feedback enables a classifier to be readily trained. This may arise because the data may be better labeled by users. Moreover, as use and sharing of classification information occurs, data is likely to be sampled and labeled from a wider social sub-demographics of users, than might arise through traditional approaches. In addition, because of the playful aspect of the animated images users are more likely to provide more feedback.

Although it is understood that a percentage of users of classifiers may not provide correct or legitimate feedback all of the time, their labeling accuracy may be reflected in their validation/fitness scores. As such, the results from user classifiers may have additional interest to researchers, marketers, and a variety of other businesses. While there may be a concern that at least some of the information obtained from such trained classifiers might be considered to be biased by the validation data set, this bias may be minimized through a variety of actions, including changing the validation data set frequently, varying a source of the validation data set, performing statistical analysis on the data set to remove detected bias, or the like. Thus, through appropriate validation data sets, and through wide spread use of the animated images to receive classifier training from different social domains, a socially unbiased sub-sampling might be obtained. Moreover, by implementing, in one embodiment, user registration, and collection of information about a user, including, but not limited to age, gender, geographic regions, education, or the like, further refinement and analysis of classification results may be performed.

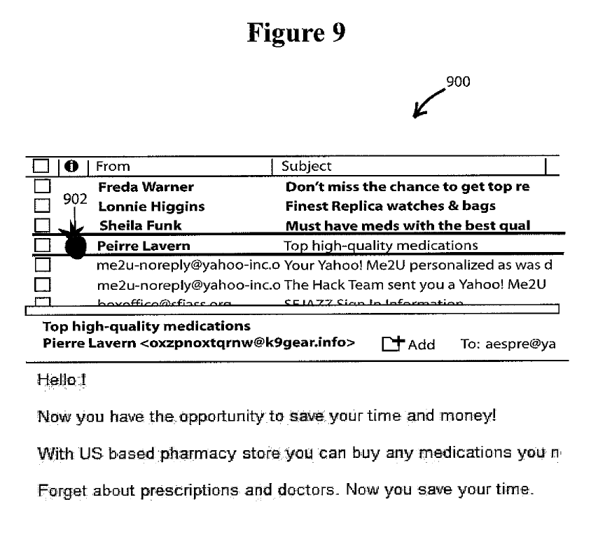

In one embodiment, game competition may be configured to obtain input from targeted groups, input for targeted labels, or the like. That is, in one embodiment, messages that may be interesting to a research group, for example, because the messages are close to the classifier's decision boundary, can be marked as “bonus” messages that give additional animation, growth, provide rewards, or other responses from the animated images. This might be the case, in one embodiment, where the user provides feedback within a pre-defined time period, such as within minutes after logging into the application, or the like. This may be additionally useful for anti-spam teams to obtain a quick label for selected messages. Again, such approach provides a clear opportunity to obtain a collective knowledge of a community for a given classification application. Thus, for example, where a suspicious Internet Protocol (IP) address has been seen as sending a spike in messages, such messages might be provided as bonus messages to users for a rapid labeling. FIG. 9 illustrates one embodiment of a non-exhaustive example of a bonus message, highlighting mechanism. As shown in screen shot 900, an icon or other symbol 902 may be employed to annotate or otherwise indicate bonus items.

Moreover, because a user's fitness score may indicate a measure of how well the user cooperates, and/or how well the user understands a classification task, the fitness score may also be used to identify users for additional activities. For example, surveys, opinions, or the like, might be sent to a subset of users based on their fitness scores to obtain additional more extensive input.

As noted above, in one embodiment, a configuration may be provided to a user that enables the user to generate a classifier. For example, a user may be presented with a choice between a personalized classifier based on any of a variety of classification mechanisms, including, but not limited to various machine learning algorithms. Non-exhaustive examples of such classifiers, includes naïve Bayes, Support-Vector machines, logistic regression, perceptron, and the like. Further, each of these algorithms may be configured in a myriad of variations, including, but not limited to regularization, feature weighting, or the like. Moreover, as users may create alliances with other users, they may therefore, combine different classification mechanisms and potentially generate many unique classifier combinations. In one embodiment, fitness scores may then be monitored for the various combinations to identify a combination that appears to provide a best fitness score, or satisfy some other criterion.

A variety of extensions to the game aspect of the present invention are also envisaged. For example, in one embodiment, users may be provided a configuration that enables one user to challenge friends to duels using their animated images/classifiers. In one embodiment, the duels may be performed against friends for whom the user has not formed an alliance. However, the invention is not so limited, and any of a variety of configurations may be implemented. In any event, in one embodiment, the duel may include a configuration whereby the classifiers of participates in the duel are tested against a secret validation data set of, for example, size n. The data set may, in one embodiment, be divided into a plurality of subsets of sizes m<<n. For each subset, a winner may be determined based on a resulting score from classifiers' actions on the subsets. Visualization using the animated images may include a variety of actions, such as adding fighting outfits to the animated images, having the animated images appear to strike another animated image, or the like. A final winner of a duel may be based, for example, on a classifier with a best score over the entire validation data set of size n.

Moreover, competition might be configured, in one embodiment, with global rankings, such as animated image/classifier Olympic type of competitions. Theses might be held in various disciplines, ranging from competing classifiers for determining drug-spam type messages, adult-spam messages, or the like. Such embodiments may be configured to give further incentive for users to train their classifiers as well as possible.

Within the context of gaming using playful animated images, in one embodiment, the games may be level based, where the classification tasks may be increased in difficulty as the user gains higher levels of game scores. A first level, for example, could include binary classifications of spam versus non-spam. Once a user obtains a well-trained classifier, the user may move up to higher level, where the user might be provided an opportunity to classify, for example, non-spam, adult-spam, drug-spam, and the like. This extension then is directed towards allowing power-users to give more fine-grained labels. This extension further may enable identification of weaknesses in a current spam classification mechanism.

In some instances, it is recognized that some users might not be exposed to enough spam messages to train their messaging classifier well. Thus, in one embodiment, one option might be provided to let the user select to automatically feed their animated image/classifier with spam messages, for example, whenever the user feeds the animated image/classifier with non-spam. In one embodiment, this selection might be made available for some period of time, until a spam/ham classification ratio is about 50:50, or the like.

In another extension, it may readily be determined which classifiers among a set of classifiers tend to make particular types of errors in classifying data from a given validation data set. Based on such information, it may be determined which combinations of classifiers might overcome such detected errors. In one embodiment, such alliances may then be encouraged using various social networking approaches, including, but not limited to, for example, having selected animated images appear to fall in love or perform other acts that are directed towards encouraging the users to form alliances. A result of such alliances is directed towards improving overall classifications and to reinforce viral marketing, and collaborative knowledge sharing.

As noted above, in another extension, animated images may be equipped with various weapons, armors, costumes, and/or other paraphernalia. For example, in one embodiment, an animated image displayed as a knight, might be enabled to select from various swords, helmets, flags, or the like. In one embodiment, the sword, or other weapon might be configured to operate as a visualization of various classification parameters, and variations, such as feature weighting. In this manner, a user might be encouraged to vary classification parameters, and other configuration settings, potentially finding an improved classifier over a previous classifier configuration.

In one embodiment, a widget, or the like, might be configured for access on a user's computer display desktop. In one embodiment, the widget might be combined with a mail-status display that indicates unread mail, or other messages. Similarly, the widget might be aligned wither another classification that provides an indication of different other types of data available for classifications. Use of this embodiment, may enable users to identify further with their classifier; it may further reduce reaction time of a user; offload computation time onto a user's desktop in instances, for example, of expensive spam classification algorithms, or the like.

In still another embodiment, an image plug-in may be provided to a messaging animated image, such as to a user's facebook, or similar type web site. In this manner, a user's animated image may be displayed on the user's image web page. This may then expose the user's animated image/classifier to potential different sources for mail. It is further directed towards advertising of playful animated image interfaces to a variety of other outside social networking domains.

While a user may employ a single playful animated image for a plurality of different classifiers, the user may also employ a different animated image for each of the different classifiers. In still another embodiment, the user may employ different classifiers for a similar application. For example, the user might employ multiple classifiers, perhaps accessible through different animated images, where each of the multiple classifiers is used to classify messages. This is directed towards allowing a user to experiment with several classifiers and/or combinations of classifiers.

### Illustrative Use Cases for Image Labeling:

As noted, the use of playful animated images as an interface to encourage user feedback to a classifier may also be employed to identify images having specific properties. In one embodiment, a large number of classifiers may be employed for identifying different images. These might range from identifying different animal images, for example, to identifying “interesting” images that are good examples of certain compositional rules for good photographs. Each such classifier may receive a plurality of images as labeled examples from which to learn a given property.

In this use case, a user may be provided with access to a playful animated image on a photography web page, such as a Flickr home page, or the like. In one embodiment, the playful animated image might be associated with a plurality of different classifiers, where each classifier might be used for a different photograph, or graphical, classification task. At any point, the user may select an option for activating one or more of the classifiers. Once a classifier is activated, it may be trained by giving it more images, and/or to classify the images.

A user may create a new classifier, in one embodiment, by clicking on an animated image, and providing a short description of a desired property. For example, in one embodiment, a user might input “images of San Francisco,” or “pictures of a dog,” “good examples of rule of thirds,” or the like. For an existing classifier, the user might activate it in order to train it with more images. The user can then look over a list of images, either from a private collection of images, or from results of a search query, or the like. The user may then mark each image as being a positive or negative example of a given property associated with the activated classifier. In one embodiment, in the background, the animated image/classifier may employ pixel information as well as meta-information in an image to train the classifier for a property. In one embodiment, even if the images are marked private, the classifier may abstract the data in terms of weights on a feature vector so that the classifier is being trained without actually divulging any information about the data to the user, or another user.

Feedback to the user may, in one embodiment, be in the form of a total score, as well as a score for each classifier associated with the animated image. The total score of the animated image can be a combined score of all the different classifiers that it represents, and the user may be able to see the scores for the individual classifiers. The score for each classifier may, in one embodiment, be a function of a) a consistency measurement of the classifier on positive-negative marks of the user, b) a component from the global score if the user has chosen to enter the animated image/classifier if, for example, the user has entered into a global competition for a given property, and/or c) a score given to this classifier by others with whom the user has selected to share a given classifier.

As in the prior use case for messaging, the concept of social networking can be applied in applications for classifying images, as well. Thus, users may allow other users to employ their classifiers; users may create classifier alliances; and so forth. Moreover, a user may be provided with options for access control, including, but not limited to sharing at an individual level, sharing to all friends within an address book, sharing so that any user can utility the user's classifier, or the like. In still another embodiment, users may turn on sharing for a subset of trusted friends, to allow this subset of friends to train the user's classifier with selected images.

A user may select to design a classifier to promote their own images, uploading images that are spam and then creating classifiers that promote such images within messages, or the like. However, use of classifiers by others might be employed to minimize proliferation of such undesirable images.

As with a variety of other classifier applications, image classifiers may be used to compare search terms to a description of a classifier, and then use the feedback of the classifier on the images as a feature for final search result ranking. Thus, as may be readily apparent, use of a playful animated image as an interface to different classifiers may enable a wide variety of different classification actions to be performed, potentially with increased user participation. Again, it should be understand that the invention is not to be construed as being limited by the use cases above, illustrations, or other examples provided herein.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A network device configured to manage a classification task over a network, comprising:
a transceiver to send and receive data over a network; and
a processor that is operative to perform actions, comprising:
receiving a selection of an animated image;
assigning the animated image to operate as a user interface to a classifier;
receiving user feedback through the animated image related to at least one action associated with a classification task of the classifier;
using the user feedback to train the classifier; and
providing a change the animated image in response to receiving the user feedback, wherein the change of the animated image is directed towards encouraging receipt of additional user feedback.

2. The network device of claim 1, wherein the animated image is useable to enable a user to configure the classifier to receive user feedback from at least one other user, wherein the user feedback from the at least one other user is useable to train the classifier.

3. The network device of claim 1, wherein the classifier is configurable to form an alliance with at least one other classifier to perform at least one classification task, using a combination of results from the classifier and the at least one other classifier.

4. The network device of claim 1, the animated image is useable to configure the classifier for competition with at least one other classifier in performing at least one classification task.

5. The network device of claim 1, wherein the processor is operative to perform actions, comprising:
determining a set of evaluation data;
employing the set of evaluation data to evaluate a classification result of the classifier; and
providing a fitness score of the classifier that is based on the evaluation, wherein the fitness score represents at least one of an ability of the classifier to predict a user's preference, or a ability of the classifier to predict a result that is consistent with a determined set of other users' classifiers.

6. A processor readable storage medium that includes data and instructions, wherein the execution of the instructions on a computing device provides for managing a classification activity over a network by enabling actions, comprising:
identifying a classifier with an animated image, wherein the animated image is configure to operate as a user interface to the classifier, and to receive user feedback about a result of the classifier;
receiving content to be classified;
employing the classifier to classifier the content;
receiving user feedback through the animated image based on a result of the classification;
using the user feedback to train the classifier; and
animating the animated image to provide recognition of the received user feedback.

7. The processor readable storage medium of claim 6, wherein the classifier is configured to perform classification of content associated with at least one of a message content, an image content, a shopping content, a music content, or video content.

8. The processor readable storage medium of claim 6, wherein the classifier is configurable through the animated image to be shared by at least one other user to perform a classification task for the other user, wherein the use of the classifier is performed such that other content submitted to the classifier for classification is inaccessible by the user.

9. The processor readable storage medium of claim 6, wherein the classifier is configurable to employ a plurality of other classifiers in combination to perform another classification task.

10. The processor readable storage medium of claim 6, wherein the animated image is configured to perform an action to request a competition between classifiers is requested.

11. The processor readable storage medium of claim 6, wherein the animated image is configured to detect a type of content and direct the content based on type to at least one other classifier.

12. A method for managing a message delivery over a network, comprising:
receiving a selection of an animated image;
associating the animated image to a classifier, wherein the animated image is configured to operate as a user interface to the classifier;
receiving content by the classifier;
receiving a classification result from the classifier for the received content;
receiving user feedback to the classification result;
using the user feedback to train the classifier; and
modifying at least a display of the animated image to indicate recognition of the user feedback.

13. The method of claim 12, further comprising:
modifying at least another display of the animated image to indicate that more user feedback is requested.

14. The method of claim 12, wherein the animated image is usable to create an alliance between the classifier and a plurality of other classifiers, wherein the alliance is useable to perform a classification task on other content, the classification task using a combination of results from the plurality of other classifiers and the classifier to generate a single classification result.

15. The method of claim 12, further comprising:
employing a set of qualification data to determine at least one fitness score for the classifier, based on results from the classifier on classifying the set of qualification data; and
modifying the display of the animated image based in part on the at least one fitness score.

16. The method of claim 12, wherein the classifier is configurable to receive user feedback from at least one other user useable to further train the classifier.

17. The method of claim 12, wherein the classifier is configurable to provide a classification result on other content received from another user, wherein the other content is received and classified transparently to a user associated with the classifier.

18. A mobile device for enabling classification of data over a network, comprising:
a memory arranged to store data and instructions;
an input interface for receiving requests and sending responses; and
a processor arranged to enable actions embodied by at least a portion of the stored instructions, the actions comprising:
displaying an animated image useable as an interface to a classifier that is configured to perform a classification task on content;
displaying a result of a classification by the classifier on received content;
enabling a user to employ the animated image to provide user feedback on the result of the classification, wherein the user feedback is useable to train the classifier; and
modifying a display of the animated image to indicate receipt of the user feedback.

19. The mobile device of claim 18, wherein the processor is arranged to perform actions, further comprising:
receiving through the animated image a selection to create an alliance with a plurality of other classifiers, at least one of the other classifiers having been trained with user feedback from another user; and
employing the alliance of classifiers to perform another classification task on other content, wherein the alliance of classifiers are configured to combine a result from each of the classifiers in the alliance to generate a single classification result.

20. The mobile device of claim 18, wherein the processor is arranged to perform actions, further comprising:
further modifying the display of the animated image to indicate that a request is received to participate in a competitive game using the classifiers.

21. The mobile device of claim 18, wherein the processor is arranged to perform actions, further comprising:
further modifying the display of the animated image to include paraphernalia configured to represent at least one classification parameter.

22. The mobile device of claim 18, wherein the processor is arranged to perform actions, further comprising:
enabling the animated image to engage in a game with another animated image.
